(19) United States
(12) Patent Application Publication
(10) Pub. No.: US 2018/0291144 A1
(43) Pub. Date: Oct. 11, 2018

(54) PROCESS FOR MAKING A POLYESTER-BASED MACROINITIATOR POLYMER

(71) Applicant: AGENCY FOR SCIENCE, TECHNOLOGY AND RESEARCH, Singapore (SG)

(72) Inventors: Hongye YE, Singapore (SG); Xian LOH, Singapore (SG)

(21) Appl. No.: 15/765,248

(22) PCT Filed: Sep. 30, 2016
(86) PCT No.: PCT/SG2016/050486

§ 371 Date: Mar. 30, 2018

(30) Foreign Application Priority Data
Sep. 30, 2015 (SG) 10201508137R

(51) Int. Cl. C08G 63/91; C08F 283/02

(52) U.S. Cl. CPC C08G 63/916; C08F 220/14; C08F 2438/01; C08F 283/02

(57) ABSTRACT

This invention relates to a method of forming a polymer comprising a step of esterifying a polyester having at least one free hydroxyl group with acyl halides or a halogen-containing carboxylic acid. The modified polyesters, made with the inventive method can be halogen-containing macroinitiator materials for further synthesis, for example, atom transfer radical polymerization as shown in other aspects of the invention. The polymers are new base materials that provide access to new Green Plastics. Articles made from the polymers are also in the scope of the invention. As an example, polyglycerol sebacate (PGS) was initially esterified into a bromine-containing macroinitiator by using bromoisobutyryl bromide (BIBB) and followed by ATRP polymerization of methyl methacrylate (MMA), thereby forming a co-polymer of PGS-g-PMMA.

### TECHNICAL FIELD

The present invention generally relates to a process for making a polyester-based polymerization macroinitiator which can be further reacted to build co-polymers. These co-polymers can be used as biodegradable materials.

### BACKGROUND ART

Many polyesters, such as polyglycerol sebacate (PGS), are biodegradable elastomers that have been widely explored for applications such as drug delivery, biocompatible coating on implantable biomedical devices and tissue engineering (such as cardiac, vascular and nervous tissues). The polyesters are often synthesized in a two-step process from polycarboxic acids and polyhydroxy alcohols with final curing.

An example is PGS where the first step is to combine the two monomers, glycerol and sebacic acid, via polycondensation at 120° C. for about 72 hours to form a PGS prepolymer. The second step cross-links the prepolymer at 120° C. for another 48 hours to form an elastomer, a process referred to as thermal curing. Due to the high temperature and long duration of synthesis, various chemical modifications had been made to improve the synthesis technique, as well as to enhance the material properties of PGS for various applications. Acrylation, for instance, was used to replace thermal curing with ultraviolet (UV) curing. This reduces the curing time of PGS from one to two days to a few hours. Urethane cross-linking was adopted to improve the ease of synthesis and co-esterification with polyethylene glycol (PEG) was performed to improve the swelling ratio and water uptake percentage of PGS.

In the case of PGS and other polyesters the final results did not deliver biodegradable and biocompatible materials which are satisfactory in all regards for the various applications. There is therefore a need to identify other methods to make such polyesters with new properties for their use as biodegradable materials.

### SUMMARY OF INVENTION

According to the invention a novel method for chemically modifying a polyester prepolymer, such as PGS prepolymer, into an atom transfer radical polymerization (ATRP) macroinitiator for the potential synthesis of a wide variety of biodegradable biocompatible polymers is provided.

According to a first aspect, there is provided a method of forming a polymer of Formula (II) comprising the steps of:

(i) providing a polyester with at least one free hydroxyl group;
(ii) esterifying said at least one free hydroxyl group with a compound of Formula (I):

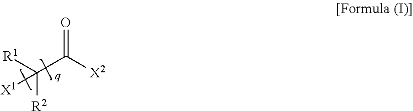

wherein R¹ and R² are independently selected from the group consisting of hydrogen, alkyl, alkenyl, alkynyl, cycloalkyl, aryl, heteroaryl, alkcycloalkyl, alkaryl, alkyl halide, alkyl alcohol and alkheteroaryl, and wherein each of R¹ and R² is optionally substituted with one or more substituents;
X¹ is a halogen;
X² is a chloro, bromo or hydroxyl; and
q is an integer of 1 to 20;
(iii) thereby forming a polymer of Formula (II):

[PE]-O-[Formula (Ia)] [Formula(II)]

wherein
PE is a polyester;
—O— is an esterified hydroxyl group; and

### Formula (Ia) is:

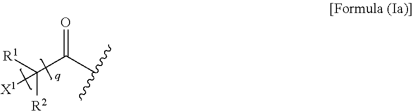

wherein X¹, R¹, R², and q are as defined in step (ii).

Advantageously, the chemically modified ester can function as macroinitiator for ATRP. The macroinitiator is robust and can be used for various different monomers which can react with it. The polyester may have a varied biodegradation profile depending on its environment. It may be a polymer with a constant biodegrading rate which is low in-vitro, but fast in vivo where enzymes are present. An example is PGS. It can therefore be the starting material for new biodegradable and biocompatible brushed polymers after further the radical polymerization. The degree of chemical modification of the polyester and therefore the initiation rate can be tuned, e.g. by adding and reacting more or less amounts of the compound of Formula (I). Further advantageously new structures of biodegradable polymers can be realized by using the inventive method. Multiple co-polymeric chains can be connected to the same polyester chain via the introduced halogen groups. The result is a network star polymer. The network core structure brings about different and unique physical and thermal properties.

Additional functionalities such as other reactive groups (thiols, biotin, amino acids etc.) can also be incorporated into the polyester backbone of Formula (II) by reacting with the reactive bromine group on the polyester macroinitiator.

According to a second aspect of the invention, there is provided a method of forming a co-polymer, comprising further reacting the polymer of Formula (II) with at least one monomer, wherein the polymer of Formula (II) is a macroinitiator for the co-polymerization reaction.

The reaction can be an atom transfer radical polymerization (ATRP). ATRP is a robust, highly efficient polymerization reaction that was developed by Krzysztof Matyjaszewski in 2001 which can be utilized with the polymers of Formula (II) made according to the invention. This allows for a highly tunable polymer synthesis method with adjustable properties of the final co-polymer. The reaction can be tuned by achieving a certain chain length of the monomer polymer chains on the network core, the degree of initiation of the polyester (controlling the number of arms on the network star) and the type of monomer used.

Furthermore, the method can be conducted sequentially (by adding different monomers in further ATRP steps) to form desired mixed co-polymers. Sequential means that the ATRP product of Formula (II) could also act as a macroinitiator for the subsequent ATRP reactions. Therefore, ATRP with different monomers may be conducted sequentially to achieve controlled co-block polymerization. Well-defined sequences of block co-polymerization can be obtained.

According to a third aspect of the invention novel polymers of Formula (II) are provided. According to one embodiment the novel polymers of Formula (IIb) are provided:

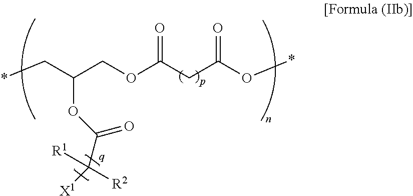

wherein R¹ and R² are independently selected from the group consisting of hydrogen, alkyl, alkenyl, alkynyl, cycloalkyl, aryl, heteroaryl, alkcycloalkyl, alkaryl, alkyl halide, alkyl alcohol and alkheteroaryl, and wherein each of R¹ and R² is optionally substituted with one or more substituents;
X¹ is a halogen;
n is an integer of 1 to 100;
p is an integer of 1 to 20; and
q is an integer of 1 to 20.

According to another embodiment the new polymers of Formula (II) are represented by Formula (IIc):

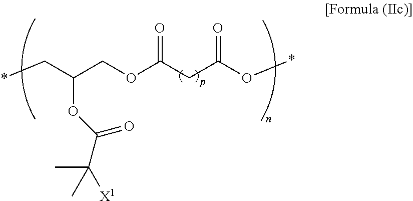

wherein X¹ is a halogen;
n is an integer of 1 to 100; and
p is an integer of 1 to 20.

According to yet another embodiment the new polymers of Formula (II) are represented by Formula (IId):

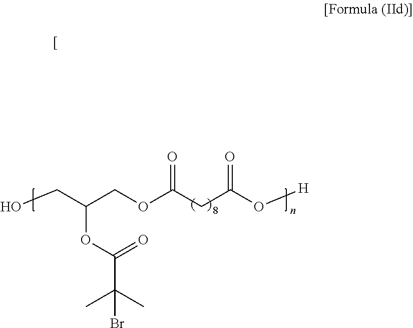

wherein n is an integer of 1 to 100.

According to a third aspect of the invention, there are provided novel co-polymers made according to the method of the second aspect of the invention.

According to one embodiment of the second aspect of the invention the novel polymers of Formula (VIa) are provided:

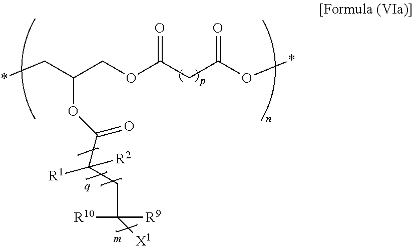

wherein R¹ and R² are independently selected from the group consisting of hydrogen, alkyl, alkenyl, alkynyl, cycloalkyl, aryl, heteroaryl, alkcycloalkyl, alkaryl, alkyl halide, alkyl alcohol and alkheteroaryl, and wherein each of R¹ and R² is optionally substituted with one or more substituents;
R⁹ is hydrogen, alkyl, alkenyl, alkynyl, cycloalkyl, aryl, heteroaryl, alkcycloalkyl, alkaryl, alkheteroaryl, amino, amide, nitrile, —COOH, and —COOR^{a}, and wherein R⁹ is optionally substituted with one or more substituents;
R¹⁰ is alkyl, alkenyl, alkynyl, cycloalkyl, aryl, heteroaryl, alkcycloalkyl, alkaryl, alkheteroaryl, amino, amide, nitrile, —COOH, and —COOR^{a}, and wherein R⁹ is optionally substituted with one or more substituents;
R^{a} is alkyl, alkenyl, alkynyl, cycloalkyl, aryl, heteroaryl, alkcycloalkyl, alkaryl, alkheteroaryl, amino, amide, and nitrile, and wherein R^{a} is optionally substituted with one or more substituents;
X¹ is a halogen;
n is an integer of 1 to 100;
p is an integer of 1 to 20;
q is an integer of 1 to 20, and
m is an integer of 1 to 2,000.

According to another embodiment of the second aspect of the invention the new polymers of Formula (II) are represented by Formula (VIb):

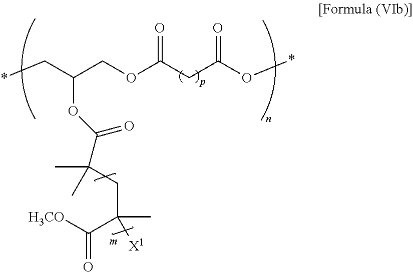

wherein
X¹ is a halogen;
n is an integer of 1 to 100;
p is an integer of 1 to 20; and
m is an integer of 1 to 2,000.

Due to their novel structure these polymers have unique physical and thermal properties.

According to a fourth aspect of the invention, there is provided an article formed from the novel polymers made according to the methods of the invention. Advantageously, such articles can find use as biodegradable materials. The method according to the invention allows modifying the polyester core chain to be tuned with different branched of predefined composition (e.g. block co-polymers). The articles formed from these polymers may have unique pre-designed capabilities when using the inventive method for making it.

### Definitions

The following words and terms used herein shall have the meaning indicated:

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in this specification, individually or collectively, and any and all combinations or any two or more of said steps or features.

As used herein, the term “alkyl” includes within its meaning monovalent (“alkyl”) and divalent (“alkylene”) straight chain or branched chain saturated aliphatic groups having from 1 to 6 carbon atoms, e.g., 1, 2, 3, 4, 5 or 6 carbon atoms. For example, the term alkyl includes, but is not limited to, methyl, ethyl, 1-propyl, isopropyl, 1-butyl, 2-butyl, isobutyl, tert-butyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl and the like. Alkyl groups may be optionally substituted.

As used herein, the term “alkenyl” refers to divalent straight chain or branched chain unsaturated aliphatic groups containing at least one carbon-carbon double bond and having from 2 to 6 carbon atoms, e.g., 2, 3, 4, 5 or 6 carbon atoms. For example, the term alkenyl includes, but is not limited to, ethenyl, propenyl, butenyl, 1-butenyl, 2-butenyl, 2-methylpropenyl, 1-pentenyl, 2-pentenyl, 2-methylbut-1-enyl, 3-methylbut-1-enyl, 2-methylbut-2-enyl, 1-hexenyl, 2-hexenyl, 3-hexenyl, 2,2-dimethyl-2-butenyl, 2-methyl-2-hexenyl, 3-methyl-1-pentenyl, 1,5-hexadienyl and the like. Alkenyl groups may be optionally substituted.

As used herein, the term “alkynyl” refers to trivalent straight chain or branched chain unsaturated aliphatic groups containing at least one carbon-carbon triple bond and having from 2 to 6 carbon atoms, e.g., 2, 3, 4, 5 or 6 carbon atoms. For example, the term alkynyl includes, but is not limited to, ethynyl, propynyl, 1-butynyl, 2-butynyl, 1-pentynyl, 2-pentynyl, 1-hexynyl, 2-hexynyl, 3-hexynyl, 3-methyl-1-pentynyl, and the like. alkynyl groups may be optionally substituted.

The term “alcohol” includes within its meaning a group that contains one or more hydroxyl moieties.

The term “aryl”, or variants such as “aromatic group” or “arylene” as used herein refers to monovalent (“aryl”) and divalent (“arylene”) single, polynuclear, conjugated and fused residues of aromatic hydrocarbons having from 6 to 10 carbon atoms. Such groups include, for example, phenyl, biphenyl, naphthyl, phenanthrenyl, and the like. Aryl groups may be optionally substituted.

The term “alkaryl” used herein is not subject to any particular restriction and includes all those compounds which comprise an aryl and an alkyl group, such as arylalkyl groups. Examples of alkaryl radicals are, for example, benzyl groups. The alkyl group in these moieties is as defined above.

The term “cycloalkyl” as used herein refers to a non-aromatic mono- or multicyclic ring system comprising about 3 to about 10 carbon atoms. The cycloalkyl can be optionally substituted with one or more “ring system substituents” which may be the same or different, and are as defined herein. Non-limiting examples of suitable monocyclic cycloalkyls include cyclopropyl, cyclopentyl, cyclohexyl, cycloheptyl and the like. Non-limiting examples of suitable multicyclic cycloalkyls include 1-decalinyl, norbornyl, adamantyl and the like. Further non-limiting examples of cycloalkyl include the following:

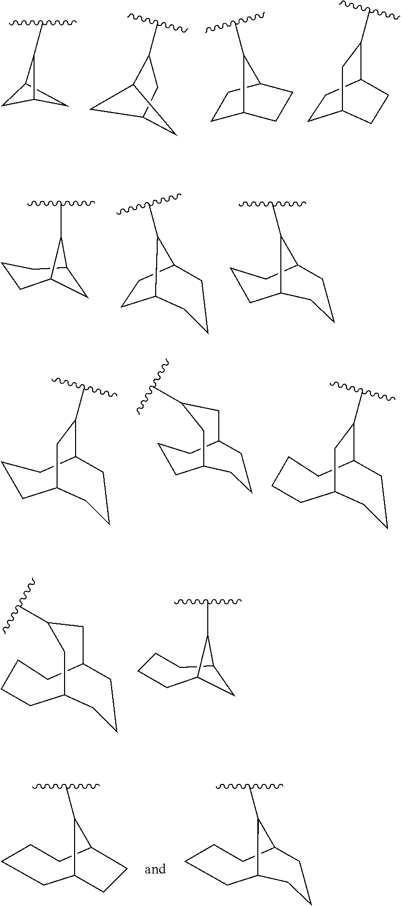

The term “alkcycloalkyl” used herein is not subject to any particular restriction and includes all those compounds which comprise a cycloalkyl group and an alkyl group, such as cycloalkylalkyl groups. Examples of alkcycloalkyl radicals are, for example, cyclohexylmethyl groups. The alkyl group in these moieties is as defined above.

The term “heteroaryl” as used herein refers to an aromatic monocyclic or multicyclic ring system comprising about 5 to about 14 ring atoms, preferably about 5 to about 10 ring atoms, in which one or more of the ring atoms is an element other than carbon, for example nitrogen, oxygen or sulfur, alone or in combination. “Heteroaryl” may also include a heteroaryl as defined above fused to an aryl as defined above. Non-limiting examples of suitable heteroaryls include pyridyl, pyrazinyl, furanyl, thienyl, pyrimidinyl, pyridone (including N-substituted pyridones), isoxazolyl, isothiazolyl, oxazolyl, thiazolyl, pyrazolyl, furazanyl, pyrrolyl, pyrazolyl, triazolyl, 1,2,4-thiadiazolyl, pyrazinyl, pyridazinyl, quinoxalinyl, phthalazinyl, oxindolyl, imidazo[1,2-a]pyridinyl, imidazo[2,1-b]thiazolyl, benzofurazanyl, indolyl, azaindolyl, benzimidazolyl, benzothienyl, quinolinyl, imidazolyl, thienopyridyl, quinazolinyl, thienopyrimidyl, pyrrolopyridyl, imidazopyridyl, isoquinolinyl, benzoazaindolyl, 1,2,4-triazinyl, benzothiazolyl and the like. The term “heteroaryl” also refers to partially saturated heteroaryl moieties such as, for example, tetrahydroisoquinolyl, tetrahydroquinolyl and the like. Heteroaryl groups may be optionally substituted.

The term “alkheteroaryl” used herein is not subject to any particular restriction and includes all those compounds which comprise a heteroaryl and an alkyl group, such as heteroarylalkyl groups. Examples of alkheteroaryl radicals are, for example, picolinyl groups. The alkyl group in these moieties is as defined above.

The term “terminal hydroxyl” as used herein refers to a free hydroxyl that is located at a terminal end position of the polymer (i.e., the hydroxyl functional group is located at the terminal ends of the polymer backbone).

The term “non-terminal hydroxyl” as used herein refers to a free hydroxyl that is located at a non-terminal end position of the polymer (i.e., the hydroxyl functional group is not located at the terminal ends of the polymer backbone).

As used herein, a monomer that contains substituents that stabilize a propagating radical includes a monomer comprising an electron withdrawing group (EWG) and an electron donating group (EDG), wherein said monomer stabilizes a propagating radical more than a monomer without either or both of such substituents. This may be due to the captodative effect of the EWG and EDG groups wherein the two groups may stabilize a radical center kinetically by preventing molecules and other radical centers from reacting with it. The EWG and EDG substituents may also thermodynamically stabilize the center by delocalizing the radical ion via resonance. These stabilization mechanisms may lead to an enhanced rate for free radical reactions.

The term “electron donating group” or “EDG” as used herein includes F, Cl, Br, I, OH, OR, —O(C═O)R′, NR′₂, SR′, SH, alkyl or the like, wherein R′ represents an organic group.

The term “electron withdrawing group” or “EWG” as used herein includes cyano, —(C═O)R′, —(S═O)OR′, NO₂, phenyl, carboxyl, carboxylic ester or the like, wherein R′ represents an organic group.

The term “optionally substituted” as used herein means the group to which this term refers may be unsubstituted, or may be substituted with one or more groups other than hydrogen provided that the indicated atom's normal valency is not exceeded, and that the substitution results in a stable compound. Such groups may be, for example, halogen, hydroxy, oxo, cyano, nitro, alkyl, alkoxy, haloalkyl, haloalkoxy, arylalkoxy, alkylthio, hydroxyalkyl, alkoxyalkyl, cycloalkyl, cycloalkylalkoxy, alkanoyl, alkoxycarbonyl, alkylsulfonyl, alkylsulfonyloxy, alkylsulfonylalkyl, arylsulfonyl, arylsulfonyloxy, arylsulfonylalkyl, alkylsulfonamido, alkylamido, alkylsulfonamidoalkyl, alkylamidoalkyl, arylsulfonamido, arylcarboxamido, arylsulfonamidoalkyl, arylcarboxamidoalkyl, aroyl, aroyl-4-alkyl, arylalkanoyl, acyl, aryl, arylalkyl, alkylaminoalkyl, a group R^{x}R^{y}N—, R^{x}OCO(CH₂)ₘ, R^{x}CON(R^{y})(CH₂)ₘ, R^{x}R^{y}NCO(CH₂)ₘ, R^{x}R^{y}NSO₂(CH₂)ₘ or R^{x}SO₂NR^{y}(CH₂)ₘ (where each of R^{x} and R^{y} is independently selected from hydrogen or alkyl, or where appropriate WRY forms part of carbocylic or heterocyclic ring and m is 0, 1, 2, 3 or 4), a group R^{x}R^{y}N(CH₂)ₚ— or R^{x}R^{y}N(CH₂)ₚO— (wherein p is 1, 2, 3 or 4); wherein when the substituent is R^{x}R^{y}N(CH₂)ₚ— or R^{x}R^{y}N(CH₂)ₚO, R^{x} with at least one CH₂ of the (CH₂)ₚ portion of the group may also form a carbocyclyl or heterocyclyl group and R^{y} may be hydrogen, alkyl. In this substituents all alkyl and aryl groups etc. are of the type defined above.

When compounded chemical names, e.g. “arylalkyl” and “arylimine” are used herein, they are understood to have a specific connectivity to the core of the chemical structure, unless defined otherwise. The group listed farthest to the right (e.g. alkyl in “arylalkyl”), is the group that is directly connected to the core. Thus, an “arylalkyl” group, for example, is an alkyl group substituted with an aryl group (e.g. phenylmethyl (i.e., benzyl)) and the alkyl group is attached to the core. An “alkylaryl” group is an aryl group substituted with an alkyl group (e.g., p-methylphenyl (i.e., p-tolyl)) and the aryl group is attached to the core. An “alkyl halide”, for example, is an alkyl group substituted with a halide group and the alkyl group is attached to the core.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Non-limiting embodiments of the invention will be further described in greater detail by reference to specific examples, which should not be construed as in any way limiting the scope of the invention.

According to a first aspect, there is provided a method of forming a polymer of Formula (II) comprising the steps of:

(i) providing a polyester with at least one free hydroxyl group;
(ii) esterifying said at least one free hydroxyl group with a compound of Formula (I):

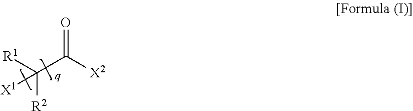

wherein R¹ and R² are independently selected from the group consisting of hydrogen, alkyl, alkenyl, alkynyl, cycloalkyl, aryl, heteroaryl, alkcycloalkyl, alkaryl, alkyl halide, alkyl alcohol and alkheteroaryl, and wherein each of R¹ and R² is optionally substituted with one or more substituents;
X¹ is a halogen;
X² is a chloro, bromo or hydroxyl; and
q is an integer of 1 to 20,
(iii) thereby forming a polymer of Formula (II):

[PE]-O-[Formula (Ia)] [Formula (II)]

wherein PE is a polyester;
—O— is oxygen linkage; and

### Formula (Ia) is:

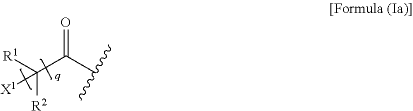

wherein X¹, R¹, R², and q are as defined in step (ii).

Step (i) may comprise a polymerization reaction by which the polyester is provided. The polyester must still contain free hydroxyl groups after the polymerization. According to various embodiments the hydroxyl can be a terminal hydroxyl or the free hydroxyl can be a non-terminal hydroxyl. The polymer may also provide both types of free hydroxyl groups. The polyester can also be provided in finished form from commercial or other sources.

In one embodiment the polyester is formed by polymerizing of a first compound comprising at least two hydroxyl groups, with a second compound comprising at least two carboxylic acid groups.

The first compound may be a polyhydroxolic compound of general Formula (VII).

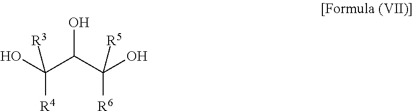

wherein R³, R⁴, R⁵ and R⁶ are independently hydrogen, alkyl, alkenyl, alkynyl, cycloalkyl, aryl, heteroaryl, alkcycloalkyl, alkaryl, alkyl halide, alkyl alcohol, alkyl carboxylic acid and alkheteroaryl, and wherein each of R³, R⁴, R⁵ and R⁶ is optionally substituted with one or more substituents. R³, R⁴, R⁵ and R⁶ may preferably be hydrogen or methyl and, most preferably, hydrogen.

In another embodiment the first compound may be a polyhydroxy alcohol having 2 to 15 carbon atoms and two to four hydroxyl groups. Examples for such polyhydroxy alcohols include ethylene glycol, propylene glycol, glycerol, sorbitol, and the like. Glycerol may be especially mentioned.

The second compound may be a polycarboxylic compound.

In one embodiment the polycarboxylic compound may be a compound of general Formula (III):

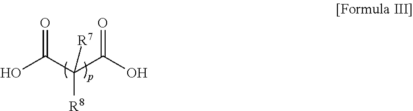

wherein p is an integer of 1 to 20; and R⁷ and R⁸ are independently hydrogen, alkyl, alkenyl, alkynyl, cycloalkyl, aryl, heteroaryl, alkcycloalkyl, alkaryl, alkyl halide, alkyl alcohol, alkyl carboxylic acid and alkheteroaryl, and wherein each of R⁷ and R⁸ is optionally substituted with one or more substituents. p may preferably be 4, 5, 6, 7, 8, 9, 10, 11, 12, 13, 14, 15 or 16. It is most preferably 7, 8 or 9. R⁷ and R⁸ are preferably hydrogen or methyl and, most preferably, hydrogen.

Non limiting examples of polycarboxylic compounds included herein are dicarboxylic acids such as 1,8-octanedioic acid (“suberic acid”), 1,10-decanedioic acid (“sebacic acid”), 1,12-dodecanedioic acid (“DDDA” and “lauric diacid”), 1,14-tetradecanedioic acid (“TDDA” and “myristic acid”), 1,16-hexadecanedioic acid (“palmitic acid”), 1,18 octadecanedioic acid (“stearic acid”), eicosanoic diacid, oleic diacid, azeleaic acid, brassylic acid, undecanedioic diacid, palmitoleic diacid, linoleic diacid, linolenic diacid, and pimelic acid. Optionally, a polycarboxylic acid of the present invention may be saturated or unsaturated, and if unsaturated, may have one, two three, four or more double bonds. 1,10-decanedioic acid (“sebacic acid”) may be especially mentioned.

The polymerization of step (i) may be run at elevated temperatures that allow for the reaction of the compounds forming the polyester. Temperatures of about 90 to about 180° C. may be used depending on the components. Preferably the temperature is between about 90 to about 140° C. A temperature range of about 110 to about 130° C. may be particularly mentioned.

Preferably the polymerization is performed at ambient pressure in a first step and under application of a partial vacuum in a second step. A typical vacuum pressure may be between about 10 and 500 mTorr, preferably 20 to 40 mTorr.

Preferably the polymerization is run in a way that the polyester is not fully cured. A prepolymer of non-fully cured polyester is then obtained. This can be achieved by choosing an appropriate short reaction time that does not lead to full cure. For instance the first step of the reaction time under ambient pressure may be less than about 30 hours. Reaction times of about 1 to 30 hours may be mentioned. For the reaction of sebacic acid and glycerol a typical reaction time is about 15 to about 28 hours. A second polymerization step under reduced pressure may be conducted for 24 to 72 hours, preferably 36 to 60 hours. To avoid full curing of the polyester one may not react the components for more than 36 hours under ambient pressure in the first step.

The polymerization for providing the polyester may be run in the absence of a solvent by reacting a polycarboxylic compound directly with a polyhydroxylic compound.

A dried or anhydrous solution of the polyhydroxylic compound may be used. The polycarboxylic compound may be used in excess or in deficiency to the molar amounts of the polyhydroxylic compound. Preferably they are used in about equimolar amounts, but also molar ratios of about 10:1, 5:1, 3:1, 1.5:1, 1.2:1, 1:1, 1:1.2, 1:1.5, 1:3, 1:5 or 1:10 can be used.

The polyester provided in step (i) according to the embodiments may be of the general Formula (IV):

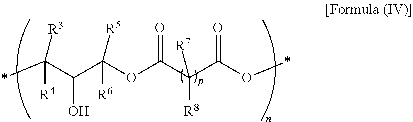

wherein R³, R⁴, R⁵, R⁶, R⁷, R⁸ and p are as defined Formula (III) or (VII); and n is an integer of 1 to 100. n may preferably be between 1 and 50 or 1 to 16. It is most preferably between 10 and 16. n may for instance be 12, 13, 14, 15 or 16.

The polyester prepared by polymerization in step (i) may be a straight chain or a branched chain polymer. It may be separated from the polymerization mixture and dried under elevated temperatures of about 30 to about 60° C.

The polyester provided in step (I) may have a molecular weight of about 100 to about 400,000 g/mol. Preferably, it may have molecular weight of about 100 to about 40,000 g/mol. More preferably, it may have molecular weight of about 100 to about 25,000 g/mol. Typical molar weights that can be mentioned include 1.00 g/mol, 2,000 g/mol, 4000 g/mol, 6000 g/mol. 8,000 g/mol, 10,000 g/mol and 15,000 g/mol.

The polyester may be a polyglycerol sebacate (“PGS”). It may be non-fully cured (“PGS prepolymer”).

Step (ii) of the method according to the invention is an esterification of at least one free hydroxyl group of the polyester provided in step (i). The reagent is a compound of general Formula (I). In Formula (I) R¹ and R² may be independently selected from the groups consisting of hydrogen, alkyl, alkenyl, alkynyl, cycloalkyl, aryl, heteroaryl, alkcycloalkyl, alkaryl, alkyl halide, alkyl alcohol and alkheteroaryl independently. In other embodiments R¹ and R² may be independently selected from the group consisting of alkyl, aryl, heteroaryl, alkylaryl, alkyl halide, alkyl alcohol and alkylheteroaryl. Preferably, R¹ and R² may be independently selected from the groups of methyl, ethyl, propyl, butyl, phenyl, -[methyl]-phenyl, -[ethyl]-phenyl, -[propyl]-phenyl, and -[butyl]-phenyl; most preferably they stand for methyl; X¹ may preferably be fluoro, chloro, bromo and iodo and, most preferably, bromo; X² may be bromo, chloro or hydroxyl. X² most preferably may be bromo. q may be an integer of 1 to 10, or more preferably 1 to 5. Most preferably q is 1.

The Formula (I) includes in its meaning halogenated esters, such as bromoisobutyryl bromide (BIBB) or 2-Bromopropionyl bromide or 2-Bromobutyryl bromide or 2-Chloropropionyl chloride.

The compound of Formula (I) may be used in stoichiometric excess to the molar amount of free hydroxyl groups available in the polyester. Typical ranges that can be mentioned for such excess are 1.5 to 25-fold, 2 to 10-fold, 3 to 8-fold, 4 to 6-fold. It may also be used in less than equimolar amounts to achieve a lower degree of modification.

The esterification of step (ii) may be performed in the presence of a basic compound. Some examples of suitable basic compounds are tertiary amines such as triethylamine, N-ethylmorpholine, N-ethyl-piperidine and inorganic bases such as the alkali metal carbonates, alkali metal bicarbonates, alkaline earth metal carbonates, alkaline earth metal oxides and the like. The basic compound may be used in equimolar amounts or in excess to the compound of Formula (I). A typical range may be 1:1 to 2:1 or more specifically 1.1:1 to 1.3:1.

The reaction is preferably carried out under substantially anhydrous conditions. Inert gases, such as nitrogen, may be purged into the reaction mixture. The reaction may be performed in an inert organic solvent. Examples of such inert (nonreactive) organic solvents include aromatic hydrocarbons such as benzene, toluene, and the xylenes; ethers such as tetrahydrofuran, tetrahydropyran, 1,3-dioxane, 1,4-dioxane, anisole, diphenylether, diethylether, and diisopropylether; and, halogenated hydrocarbons such as chloroform, dichloromethane, chlorobenzene, dichloroethane, trichloroethane, and the chlorofluorocarbons.

The reaction times for the esterification in step (ii) may vary widely depending on the reagents used. Usually reaction times of 4 to 48 hours, preferably 10 to 24 hours, can be mentioned. The reaction product may be separated and purified by known methods of separation, e.g. centrifugation followed by precipitation into a non-solvent, such as ether.

The reaction results in a modified polymer of general Formula (II), wherein all or a part of the previously available hydroxyl groups are esterified. The compound of Formula (II) may be represented by general formula (IIa) according to one embodiment:

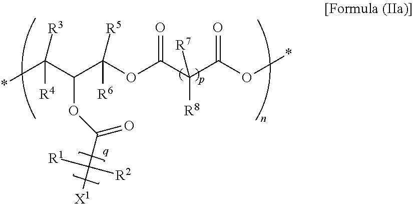

wherein R¹, R², R³, R⁴, R⁵, R⁶, R⁷, R⁸, X¹, n, p, and q are as defined in Formula (I), (III), (IV) or (VII) respectively.

According to another embodiment, Formula (II), depending on the starting materials used, may be represented by general Formula (IIb):

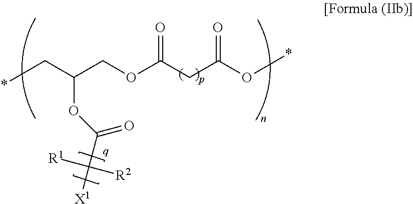

wherein R¹, R², X¹, n, p and q are as defined in Formula (I), (III), (IV) or (VII) respectively.

According to another embodiment, Formula (II), depending on the starting materials used, may be represented by general Formula (IIc):

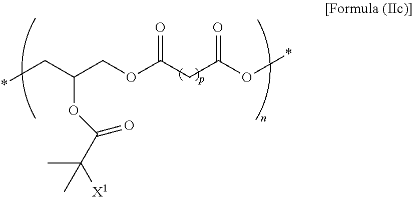

wherein X¹, n and p are defined as above.

According to yet another embodiment, when sebacic acid, glycerol and BIBB are used, Formula (II) may be represented by general Formula (IId):

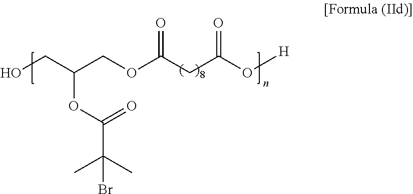

wherein n is as defined above for Formula (IV).

The obtained polymer of Formula (II) may have a molecular weight of about 100 to about 500,000 g/mol. Preferably, it may have molecular weight of about 100 to about 50,000 g/mol. More preferably, it may have molecular weight of about 100 to about 5,000 g/mol. Typical molar weights that can be mentioned include 2,000 g/mol, 3,000 g/mol, 4,500 g/mol, 5,000 g/mol, 6000 g/mol, 8,000 g mol, 10,000 g/mol, 15,000 g/mol.

The polymers of Formula (IIb), (IIc) and (IId) are novel and as such also part of the invention.

According to a second aspect of the invention, there is provided a method of forming a co-polymer, comprising further reacting the polymer of Formula (II) with at least one monomer, wherein the polymer of Formula (II) is a macroinitiator for the co-polymerization reaction.

The compound of Formula (II) (“modified prepolymer”) can be made according to the first aspect of the invention. The polymer may be reacted in a co-polymerization with the monomer in an atom transfer radical polymerization (ATRP). This reaction type was for instance described by Krzysztof Matyjaszewski et al. (Chem. Rev., 2001, 101 (9), pp 2921-2990).

According to the second aspect of the invention the method may be a method wherein at least one monomer stabilizes a propagating radical. The method may further comprise the use of a monomer with an electron withdrawing group and an electron donating group.

The monomer in the co-polymerization may be a vinyl monomer. It may be selected from methacrylates, methyl methacrylates, acrylates, styrenes, methyl acrylamides, acrylamides, methacrylonitriles, acrylonitriles, and dienes. Methacrylates may be preferred according to one embodiment of the invention. The methacrylates may be optionally substituted.

The monomer may have the following general Formula (V)

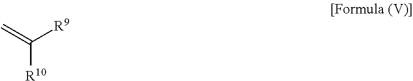

Wherein R⁹ is hydrogen, alkyl, alkenyl, alkynyl, cycloalkyl, aryl, heteroaryl, alkcycloalkyl, alkaryl, alkheteroaryl, amino, amide, nitrile, —COOH, and —COOR^{a}, and wherein R⁹ is optionally substituted with one or more substituents;
R¹⁰ is alkyl, alkenyl, alkynyl, cycloalkyl, aryl, heteroaryl, alkcycloalkyl, alkaryl, alkheteroaryl, amino, amide, nitrile, —COOH, and —COOR^{a}, and wherein R⁹ is optionally substituted with one or more substituents; and
R^{a} is alkyl, alkenyl, alkynyl, cycloalkyl, aryl, heteroaryl, alkcycloalkyl, alkaryl, alkheteroaryl, amino, amide, and nitrile, and wherein R^{a} is optionally substituted with one or more substituents.

According to a preferred embodiment R⁹ is C₁-C₃-alkyl, R¹⁰ is —COOR^{a} and R^{a} is C₁-C₃-alkyl.

R^{a} may be itself a polymeric chain, such as poly (ethylene glycol). The finally obtained polymer may then be of a (long-)brush type.

The monomer can be used in various mass ratios to the modified prepolymer depending on the desired characteristics of the final co-polymer. The following mass ratios of monomer to modified prepolymer can be mentioned as examples: 1:2, 1:1, 10:1, 25:1, 35:1, 45:1, 55:1, 65:1, 75:1, 90:1 etc. The ratios define typical ranges of uses. Preferably the monomer is used in excess to the modified prepolymer to obtain a co-polymer with a prepolymer core with pre-designed radiating co-polymer chains of the polymerized monomer.

Ligands may be used in the ATRP. Ligands suitable for use as an electron donor in ATRP include, but are not limited to: DMA (N,N-dimethylacetamide), HMTETA (1,1,4,7,10,10-hexamethyltriethylenetetramine), PMDETA (N,N,N′,N′,N″-Pentamethyldiethylenetriamine), tNtpy (4,4′,4″-tris(5-nonyl)-2,2′:6′,2″-terpyridine), Me6TREN (Tris(2-dimethylaminoethyl)aminea), BPMODA (N,N-bis(2-pyridylmethyl)octadecylamine), TPEDA (N,N,N′,N′-tetra[(2-pyridal)methyl]ethylenediamine), TPMA (tris[(2-pyridyl)methyl]amine), TREN (tris(2-aminoethyl)amine), BA6TREN (tris(2-bis(3-butoxy-3-oxopropyl)aminoethyl)amine, EHA6TREN (tris(2-bis(3-(2-ethylhexoxy)-3-oxopropyl)aminoethyl)amine), LA6TREN (Tris(2-bis(3-dodecoxy-3-oxopropyl)aminoethyl)amine), dNbpy (4,4′-Di-5-nonyl-2,2′-bipyridine) and bpy (2,2′-bipyridine). HMTETA can be specifically mentioned.

The choice of ligand amount is not crucial. A catalytic amount may be sufficient. Typical ligand molar ratios versus the number of moles of initiating groups in the macroinitiator (for instance, the bromine group) are in the range of 0.1 to 10, preferably 3 to 7.

Various transition metal catalysts can be used in the ATRP copolymerisation reaction. The transition metal catalysts are selected from a transition metal, a transition metal salt or a transition metal complex. The transition metal catalyst may be selected from molybdenum, ruthenium, tellurium, chromium, rhenium, copper, palladium, cobalt, iron, titanium, rhodium, and nickel, or a salt or complex thereof. The transition metal salt or transition metal complex may be selected from the group consisting of a chloride, bromide, nitrate, sulfate, oxide, dioxide, hydroxide, and carbonate salt or complex. Cupper salts may be preferred, such as Cu(I) bromide or Cu(II) bromide.

The choice of catalyst amount is not crucial. A catalytic amount may be sufficient. Typical molar ratios of catalyst to the initiator are in the range of 0.1 to 5, preferably 1.2 to 1. The catalyst may be used in about equimolar amounts to the ligand.

The co-polymerization may be performed in a protic or aprotic solvent. If a protic solvent is used, the solvent may be water, an alcohol or mixtures thereof. The alcohol may be, for example, methanol, ethanol, propanol, isopropanol, butanol, isobutanol, heptanol, or mixtures thereof. Embodiments of the present invention also include co-polymerizing the radically polymerizable monomers in an aprotic media, wherein the aprotic media comprises an aromatic solvent, such as, but not limited to anisole, xylene, toluene, benzene, a halogenated benzene derivative, or non-aromatic aprotic solvents such as, but not limited to tetrahydrofuran (THF), acetone, dimethylformamide (DMF), dimethylsulfoxide (DMSO), 1,4-dioxane or other aprotic solvents,

The co-polymerization may be run at elevated temperatures that allow for the reaction of the compounds forming the co-polymer. Temperatures of about 30 to about 80° C. may be used depending on the components. Preferably the temperature is between about 40 to about 60° C.

The final polymer is separated from the reaction solution of the co-polymerization by known separation techniques. Such separation techniques comprise filtration with separation column to separate off the catalyst followed by precipitation of the polymer in a non-solvent, such as a non-polar solvent, after evaporating the solvent partly.

Depending on the reaction procedure and the monomer chosen, the final co-polymer may be a block co-polymer, a graft co-polymer or a brush co-polymer.

Block co-polymers may be obtained by first performing a co-polymerization with one monomer followed by a polymerization with another different monomer. This sequential co-polymerization is another embodiment of the invention. It may be especially suitable when the co-polymerizations are of an ATRP reaction type which can be started with one monomer and continued with another monomer.

Brush co-polymers can be obtained by using a monomer with a side chain, such as a substituted methacrylate.

The obtained co-polymer may have a molecular weight of about 500 to about 5,000,000 g/mol. Preferably, it may have molecular weight of about 1,000 to about 100,000 g/mol. More preferably, it may have molecular weight of about 5,000 to about 75,000 g/mol. Typical molar weights that can be mentioned include 10,000 g/mol, 20,000 g/mol, 35,000, g/mol 55,000 g mol.

The co-polymer obtained may be represented by general formula (VI)

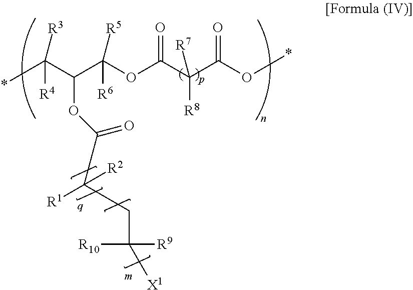

wherein R¹, R², R³, R⁴, R⁵, R⁶, R⁷, R⁸, R⁹, R¹⁰, X¹, n, p and q are as defined as above; and m is an integer of 1 to 2,000. m may be between 1 to 1,000, 5 to 50 or 40 to 500. It is most preferably between 10 to 100. m may for instance be 5, 10, 20, 30, 40 or 80.

According to another embodiment the co-polymer obtained may be represented by general formula (VIa)

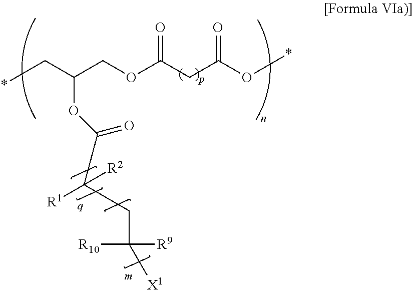

wherein R¹, R², R⁹, R¹⁰, X¹, n, p and m are defined as above.

According to yet another embodiment the co-polymer obtained may be represented by general formula (VIb)

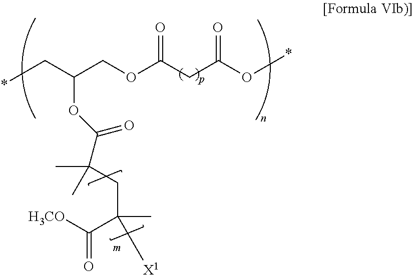

wherein X¹, n, p and m are as defined as above. p may be the integer 8, if sebacic acid is used.

The co-polymers of Formula (VIa), and (VIb) are novel and as such also part of the invention.

According to a fourth aspect of the invention, there is provided an article formed from the novel polymers made according to any of the methods the invention. Such article can utilize the specific capabilities of the polymers. The article can be formed by casting an optionally buffered solution of the polymer alone or in admixture with other known polymers on a casting substrate followed by evaporation of the solvent. They can however, by also formed by known methods of hydrogel formation from (buffered) polymer solutions optionally comprising other known polymers.

Such articles can be biodegradable plastics, biocompatible and/or biodegradable gels for biomedical and consumer products, biocompatible and/or anti-bacterial products, biodegradable and/or biocompatible functional polymers for biomedical and consumer products, surfactants, drug delivery vehicles, cell encapsulation agents, micelles, and trigger sensitive sensing polymers.

### Examples

Non-limiting examples of the invention and a comparative example will be further described in greater detail by reference to specific Examples, which should not be construed as in any way limiting the scope of the invention.

### Chemicals, Materials and Methods

Glycerol, sebacic acid, triethylamine (TEA), anhydrous tetrahydrofuran (THF), bromoisobutyryl bromide (BIBB), methyl methacrylate monomer (MMA) 1,1,4,7,10,10-hexamethyltriethylenetetramine (HMTETA), copper (I) bromide and triethylamine (TEA) were purchased from Sigma-Aldrich, Nucleos, Singapore. All solvents were purchased from Sigma-Aldrich in anhydrous form and used without further purification. All other reagents were used as received, except where otherwise noted.

Differential Scanning calorimeter (DSC) thermal analysis was performed on a DSC (Q100, TA Instruments, USA) equipped with an autocool accessory and calibrated using indium. A cycling temperature range of −50° C. to 200° C. was chosen with a ramp rate of 20° C./min. Data was obtained from the second heating run.

Tensile tests were done on an Instron 5569 universal testing machine with a 100 N load cell. Samples were first cast into sheets by solvent casting technique before being cut into a dog-bone shape using a die cutter. The samples were pulled at a strain rate of 50 mm/min until sample failure. Triplicates were performed for each sample and an average was obtained.

Polymer samples were dissolved in deuterated chloroform (CDCl₃) at 1 mg/mL and transferred into NMR tubes. H¹ NMR was performed on a Bruker NMR, 400 MHz, USA.

Molecular weights of the polymers were determined by the gel permeation chromatography (GPC, company, country). Samples were prepared by dissolving in HPLC-grade THF at a concentration of 1 mg/mL and filtering through 0.22 μm PTFE filters. The samples were injected at 100 μL into the GPC column (5 μm, 300×7.8 mm, Phenomenex, USA) at a flow rate of 1.0 mL/min. The molecular weights were calculated based on the calibration curve of polystyrene standards.

### DESCRIPTION OF DRAWINGS

The accompanying drawings illustrate a disclosed embodiment or reaction scheme and serve to explain the principles of the disclosed embodiments. It is to be understood, however, that the drawings are designed for purposes of illustration of examples only, and not as a limitation of the invention.

FIG. 1 is a schematic drawing of the synthesis of PGS prepolymer.

FIG. 2 is a schematic drawing of the bromination reaction of PGS prepolymer.

FIG. 3 shows an NMR spectra of unmodified PGS prepolymer

FIG. 4 shows an NMR spectra of PBS-Br according to Example 2. FIG. 4 A: PGS-Br with a degree of bromination of 94%. FIG. 4 B: A repeat with the same experimental conditions as 4A, also with 94% of bromination.

FIG. 5 shows an NMR spectra of PGS-Br with a partial bromination of PGS.

FIG. 6 shows a zooming-in to the peaks corresponding to the free hydroxyl group on PGS during bromination. Lines top to bottom: (1) PGS, (2) PGS—partial bromination, (3) PGS—bromination completion, (4) PGS—bromination completion (repeat).

FIG. 7 shows a zooming-in on the peaks between 1-2.5 ppm during bromination. Lines top to bottom: (1) PGS, (2) PGS—partial bromination, (3) PGS—bromination completion, (4) PGS—bromination completion (repeat).

FIG. 8 shows the APTR reaction using PGR-Br.

FIG. 9 shows the NMR spectra of PGS-PMMA made with a monomer: initiator ratio of 25:1 (PGS-PMMA short, top line) and 75:1 (PGS-PMMA long, bottom line). Due to the high proportion of PMMA to PGS, the peaks of the original PGS are not visible.

FIG. 10 shows the tensile testing results for 100% PMMA sheets (5 samples).

FIG. 11 shows the tensile testing results for the 50% PMMA and 50% PGS-PMMA sheets (3 samples).

### EXAMPLE 1

### Preparation of PGS-Prepolymer (not Fully Cured)

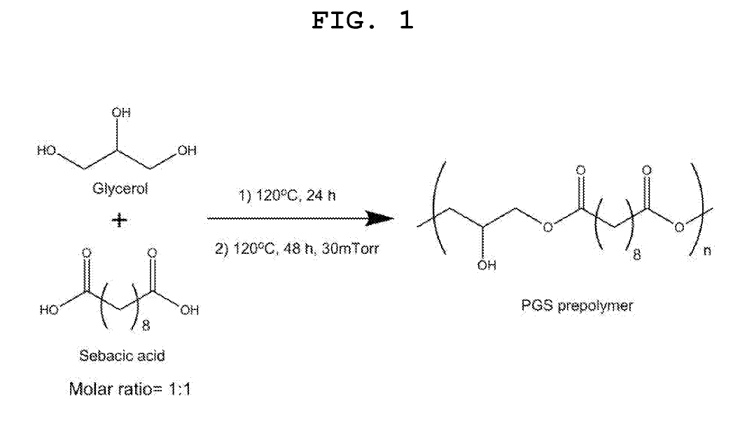

Glycerol was dried at 120° C. under vacuum. An equimolar amount of sebacic acid and dried glycerol in 1:1 molar ratio was weighed and mixed at 120° C. under N₂ for 24 hours. The mixture was reacted at 120° C. under 30 mTorr vacuum for 48 hours (FIG. 1).

### Chemical Modification by Bromination of Prepolymer to Final ATRP Macroinitiator (PGS-Br)

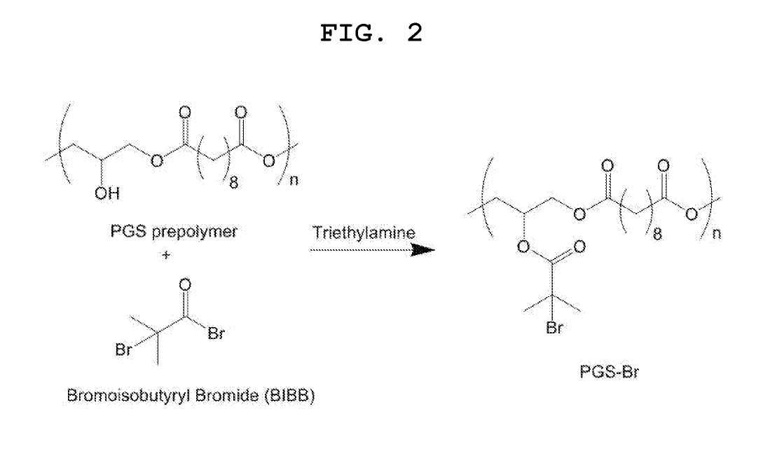

2 g of PGS prepolymer was dried at 50° C. under vacuum overnight and purged with N₂ for 1 hour, before dissolving in 15 mL of anhydrous THF. Triethylamine (TEA) of 1.2 molar times to bromoisobutyryl bromide (BIBB) was added. BIBB at 5 molar ratio of the number of moles of hydroxyl groups was added and reacted overnight (FIG. 2). The reaction mixture was centrifuged and the supernatant was precipitated in ether.

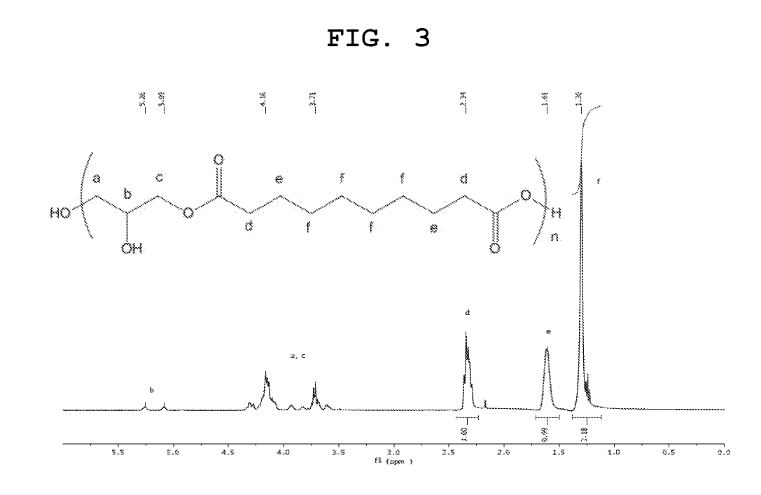

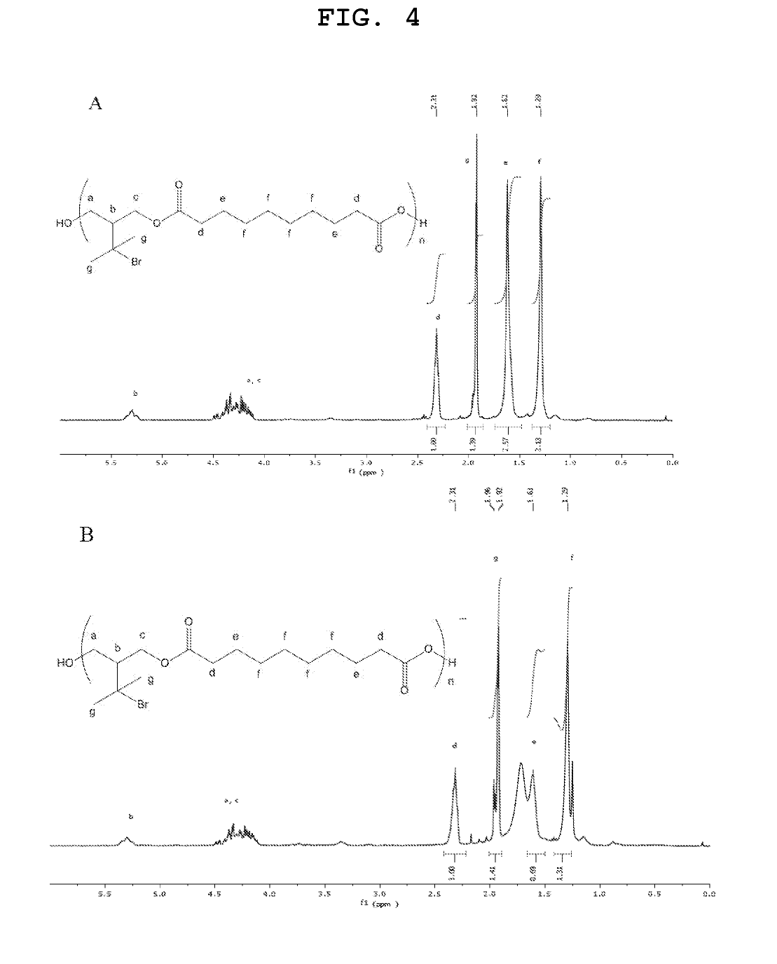

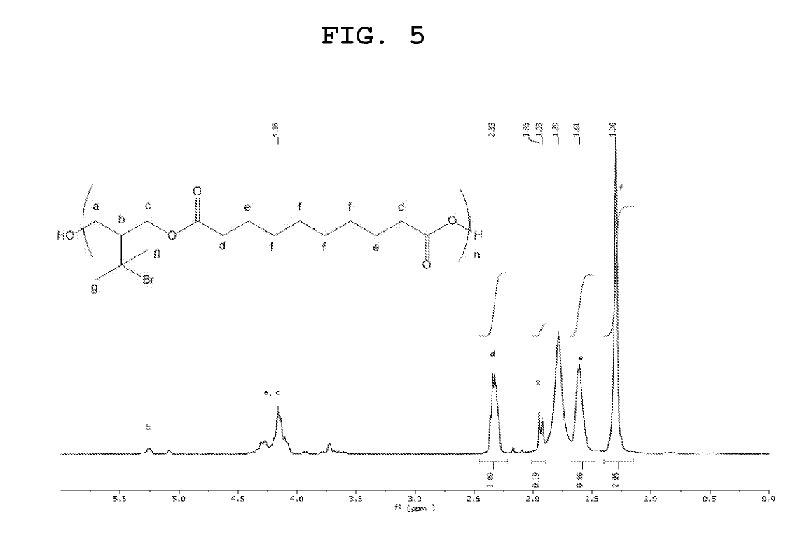

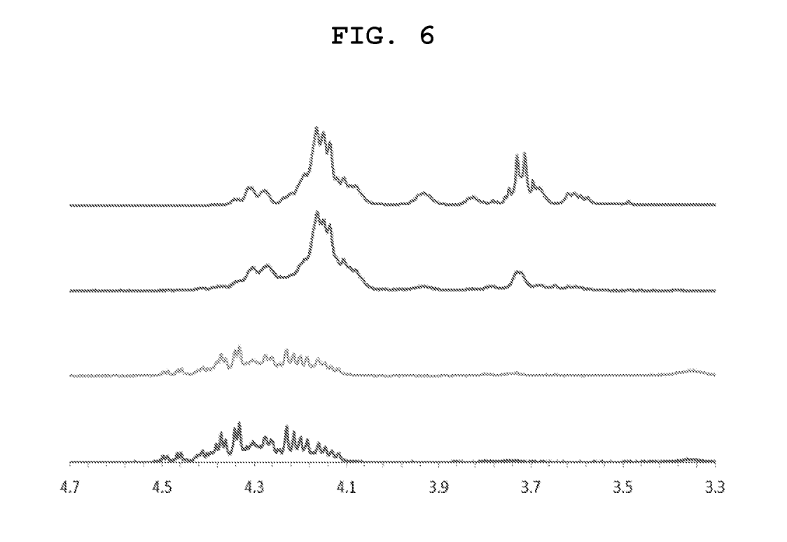

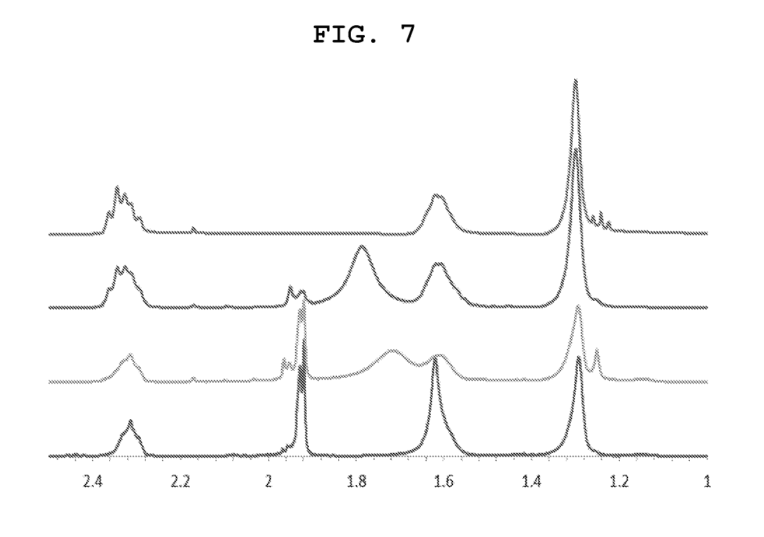

Results of the achieved bromination are shown in FIGS. 3 to 7. FIG. 4 shows that an NMR of PGS-Br can be used to quantify the degree of bromination by comparing the integral of the peak at 1.9 ppm (peak g) and the integral of the peak at 2.3 ppm (peak d). FIGS. 4 A and B demonstrate the reproducibility of the bromination method. FIG. 5 shows that with less bromoisobutyrate bromide (BIBB), the peak at 1.9 ppm is significantly smaller. The degree of bromination was then 13%. FIG. 6 shows that the degree of bromination increases, because the peak at 3.7 ppm decreases. This indicates the substitution of the free hydroxyl group by the BIBB molecule. FIG. 7 shows that the peak corresponding to the BIBB (1.9 ppm) increases with increased degree of bromination. The percentage of bromination is obtained by taking the ratio of the peak at 1.9 ppm to the peak at 2.3 ppm, normalized to the number of each type of proton.

### EXAMPLE 2

ATRP Reaction with the PGS Macroinitiator

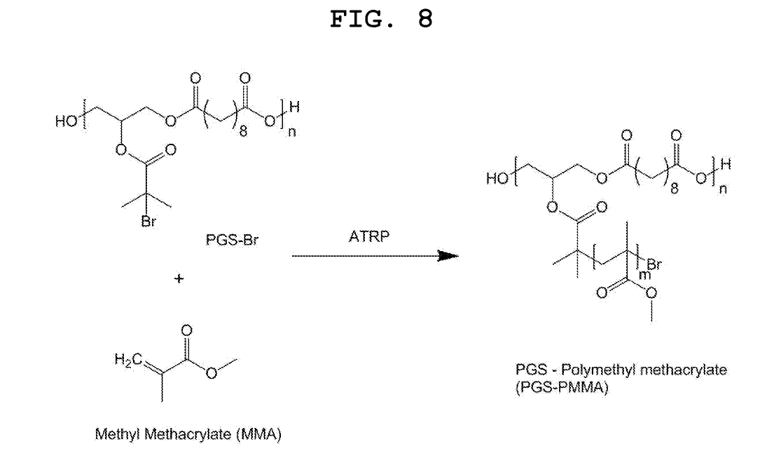

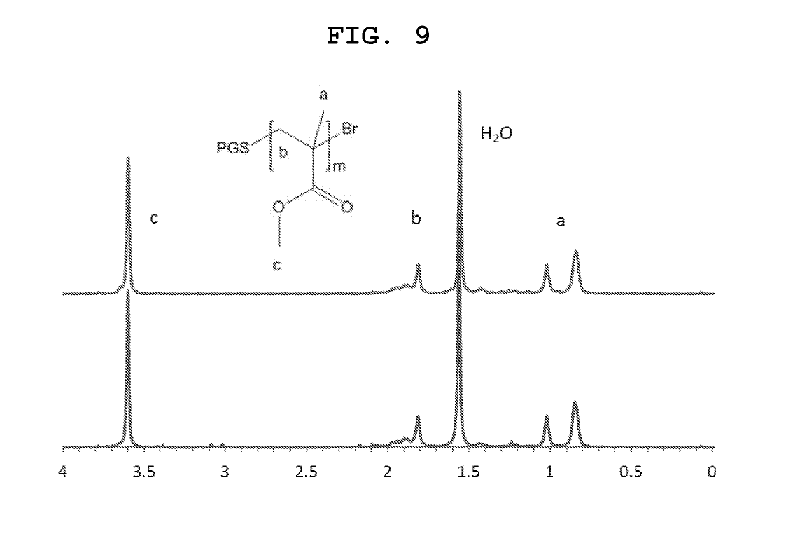

ATRP monomer (here example methyl methacrylate) and 0.04 g of PGS-Br in the mass ratio of 25:1 and 75:1 were added with 176 mg 1,1,4,7,10,10-Hexamethyltriethylenetetramine (HMTETA) as the initiator and dissolved in 10 mL of isopropanol (FIG. 8). The mixture was bubbled with nitrogen for 45 min before a catalytic amount of copper(I) bromide was added as the catalyst. The mixture was reacted overnight at room temperature or 50° C. Aluminum oxide column (about 5 cm) was used to remove the catalyst and the filtrate was concentrated with a rotovap. The concentrated polymer was precipitated in hexane twice and dried in vacuum overnight and characterized using NMR (FIG. 9).

Characterization of the Product of Example 2 after Solvent Casting:

PGS-PMMA was dissolved in tetrahydrofuran (THF). The control of commercially available PMMA (350 kDa) was also dissolved in THF. Sheets of PMMA or PGSPMMA were casted in a 10 mm glass petri dish. The sheets were then vacuumed at 50° C. overnight to dry out the solvent. Sheets of 100% PMMA (control) and 50% PMMA (350 kDa)/50% PGS-PMMA (25 kDa) were prepared. The sheets were punched into a dog-bone shape and performed tensile testing on an Instron machine.

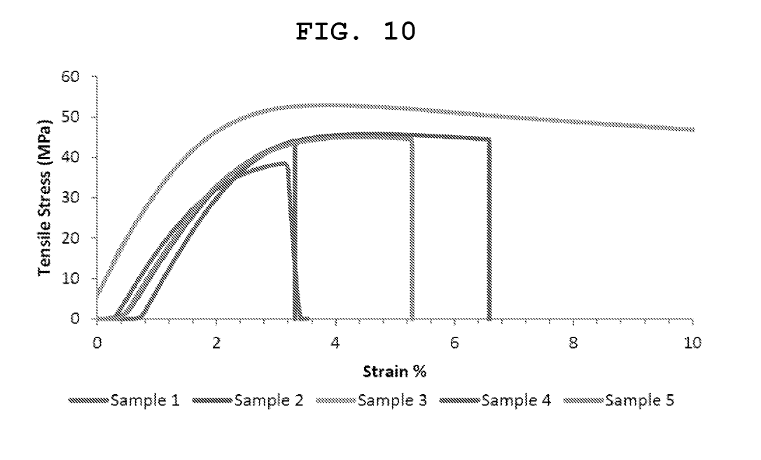

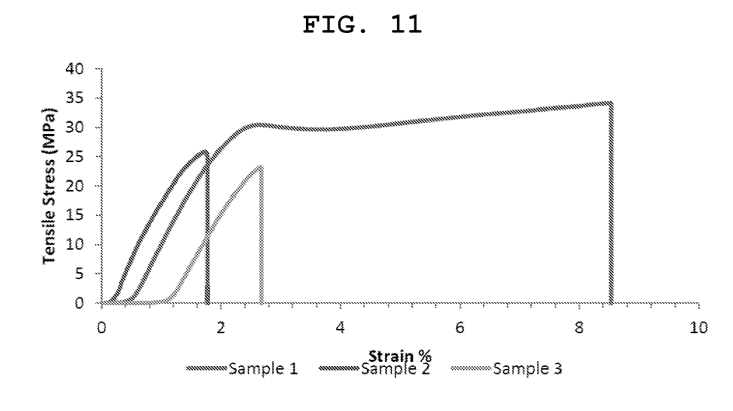

The behaviour of the 50 PGS-PMMA polymer addition was determined from the graphs in FIGS. 10 and 11. The average modulus is significantly lower for the admixture with the polymer made according to the inventive method (1.79±0.04 GPa, standard deviation for 3 samples) than the 100% PMMA polymer (2.27±0.14 GPa, standard deviation for 5 samples).

### Characterization of the Product of Example 2 in a DSC Experiment:

DSC experiments were performed on the PGS-PMMA polymer on comparison to PGS polymer.

TABLE 1

| | | | | | # repeating |
|---|---|---|---|---|---|
| | | | | | units (n |
| | | | | M_{w} | and m; see |
| Samples | Tₘ (° C.) | T_{c} (° C.) | T_{g} (° C.) | (g/mol) | FIG. 8) |
| PGS | 8.3 | −11.8 | −16.5 | 4,084 | n = 15 |
| PGS- | Non detected | Non detected | 90.5 | 18,026 | n = 15 |
| PMMA | | | | | m = 11 |
| (25:1) | | | | | |
| PGS- | Non detected | Non detected | 114.6 | 29,898 | n = 15 |
| PMMA | | | | | m = 20 |
| (75:1) | | | | | |

[Tab. 1] shows the results of DSC that was performed on the samples from −80° C. to 200° C. It lists the melting temperature (Tₘ), crystallization temperature (T_{c}), glass transition temperature (T_{g}), thermal decomposition temperature (T_{d}), molecular weight (Mw) and the number of repeating units in the polymers.

### INDUSTRIAL APPLICABILITY

The method according to the first aspect of the invention can be used to make a base material for synthesis of other biodegradable polymers for various applications such as biodegradable plastic, biocompatible and biodegradable gel for biomedical and consumer products, biocompatible anti-bacterial polymers and various other applications. The method according to the second aspect of the invention provides such polymers after co-polymerization. The polymers may have unique properties due to the predesigned structure with a polyester core and radiating co-polymer chains forming graft polymers, block-polymers or brush polymers. Elastic behaviour and viscosity can be influenced according to the application needs. Typical applications include the use of such biodegradable polymers in food packaging or drug delivery applications. The method provides new ways to make Green Plastics.

It will be apparent that various other modifications and adaptations of the invention are available to the person skilled in the art after reading the foregoing disclosure without departing from the spirit and scope of the invention and it is intended that all such modifications and adaptations come within the scope of the appended claims.

1.-44. (canceled)

45. A method of forming a polymer of Formula (II) comprising:
(i) providing a polyester with at least one free hydroxyl group;
(ii) esterifying said at least one free hydroxyl group with a compound of Formula (I): 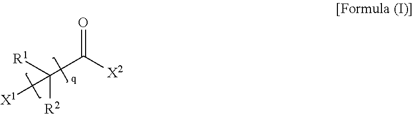
wherein R¹ and R² are independently selected from the group consisting of hydrogen, alkyl, alkenyl, alkynyl, cycloalkyl, aryl, heteroaryl, alkcycloalkyl, alkaryl, alkyl halide, alkyl alcohol and alkheteroaryl, and wherein each of R¹ and R² is optionally substituted with one or more substituents;
X¹ is a halogen;
X² is a chloro, bromo or hydroxyl; and
q is an integer of 1 to 20,
(iii) thereby forming a polymer of Formula (II):
[PE]-O-[Formula (Ia)] [Formula (II])]
wherein PE is a polyester;
—O— is an oxygen linkage; and
Formula (Ia) is: 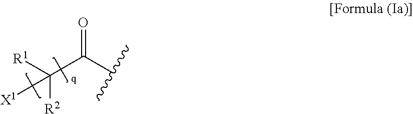
wherein X¹, R¹, R², and q are as defined in operation (ii).

46. The method of claim 45, wherein q is an integer of 1 to 10, or 1 to 5.

47. The method of any one of claim 45, wherein the free hydroxyl is a terminal hydroxyl or a non-terminal hydroxyl.

48. The method of claim 45, wherein R¹ and R² are independently selected from the group consisting of hydrogen, alkyl, alkenyl, alkynyl, cycloalkyl, aryl, heteroaryl, alkcycloalkyl, alkaryl, alkyl halide, alkyl alcohol and alkheteroaryl or further selected from the group consisting of alkyl, aryl, heteroaryl, alkylaryl, alkyl halide, alkyl alcohol and alkylheteroaryl or further selected from the group consisting of methyl, ethyl, propyl, butyl, phenyl, -[methyl]-phenyl, -[ethyl]-phenyl, -[propyl]-phenyl, and -[butyl]-phenyl.

49. The method of claim 45, wherein X¹ is independently selected from the group consisting of fluoro, chloro, bromo, and iodo, and X² is independently selected from the group consisting of bromo, chloro or hydroxyl.

50. The method of claim 45, wherein the polyester is formed by polymerizing a first compound comprising at least two hydroxyl groups, with a second compound comprising at least two carboxylic acid groups or
wherein the first compound is of Formula (VII): 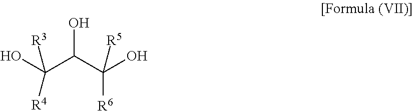
wherein R³, R⁴, R⁵ and R⁶ are independently hydrogen, alkyl, alkenyl, alkynyl, cycloalkyl, aryl, heteroaryl, alkcycloalkyl, alkaryl, alkyl halide, alkyl alcohol, alkyl carboxylic acid and alkheteroaryl, and wherein each of R³, R⁴, R⁵ and R⁶ is optionally substituted with one or more substituents or
wherein the second compound is of Formula (III): 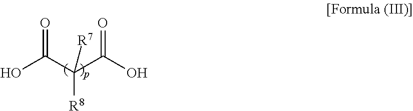
wherein p is an integer of 1 to 20; and
R⁷ and R⁸ are independently hydrogen, alkyl, alkenyl, alkynyl, cycloalkyl, aryl, heteroaryl, alkcycloalkyl, alkaryl, alkyl halide, alkyl alcohol, alkyl carboxylic acid and alkheteroaryl, and wherein each of R⁷ and R⁸ is optionally substituted with one or more substituents.

51. The method of claim 45, wherein the polyester of operation (i) is a compound of Formula (IV): 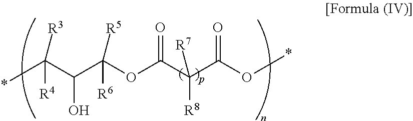
wherein R³, R⁴, R⁵, R⁶, R⁷, R⁸ and p are as defined in claim 50; and
n is an integer of 1 to 100 or 1 to 50 or 1 to 16.

52. The method of claim 45, wherein the polymer of Formula (II) is of Formula (IIa): 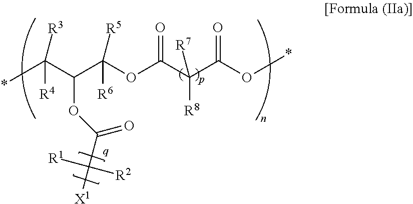
wherein R¹, R², R³, R⁴, R⁵, R⁶, R⁷, R⁸, X¹, n, p, and q are as defined in claims 45, 46, 48, 49, 50, and 51, or Formula (IIb): 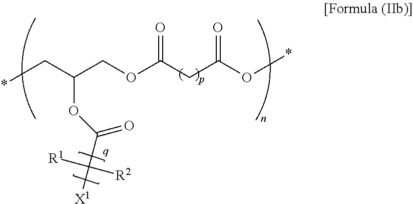
wherein R¹, R², X¹, n, p and q are as defined in claims 45, 46, 48, 49, 50, and 51, or Formula (IIc): 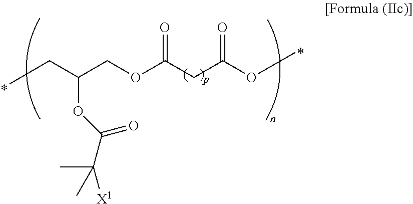
wherein X¹, n and p are as defined in claims 45, 49, 50 and 51, or Formula (IId): 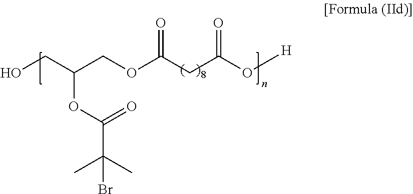
wherein n is as defined in claims 57, 58 and 59.

53. The method of claim 45 wherein the polymer of formulas (II), (IIa), (IIb), (IIc) or (IId) has a molecular weight of about 100 to about 500,000 g/mol or about 100 to about 50,000 g/mol or about 100 to about 5,000 g/mol.

54. A method of forming a co-polymer, comprising reacting the polymer of Formulas (II), (IIa), (IIb), (IIc) or (IId) of claim 45 with at least one monomer, wherein said polymer of Formula (II), (IIa), (IIb), (IIc) or (IId) is a macroinitiator for the co-polymerization reaction.

55. The method of claim 54, wherein the at least one monomer stabilizes a propagating radical and comprises an electron withdrawing group and an electron donating group or wherein the at least one monomer is a vinyl monomer.

56. The method of claim 54, wherein the monomer is of Formula (V): 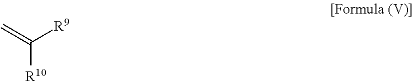
wherein R⁹ is hydrogen, alkyl, alkenyl, alkynyl, cycloalkyl, aryl, heteroaryl, alkcycloalkyl, alkaryl, alkheteroaryl, amino, amide, nitrile, —COOH, and —COOR^{a}, and wherein R⁹ is optionally substituted with one or more substituents;
R¹⁰ is alkyl, alkenyl, alkynyl, cycloalkyl, aryl, heteroaryl, alkcycloalkyl, alkaryl, alkheteroaryl, amino, amide, nitrile, —COOH, and —COOR^{a}, and wherein R⁹ is optionally substituted with one or more substituents; and
R^{a} is alkyl, alkenyl, alkynyl, cycloalkyl, aryl, heteroaryl, alkcycloalkyl, alkaryl, alkheteroaryl, amino, amide, and nitrile, and wherein R^{a} is optionally substituted with one or more substituents.

57. The method of claim 54, wherein the at least one monomer is selected from the group consisting of methacrylates, methyl methacrylates, acrylates, styrenes, methyl acrylamides, acrylamides, methacrylonitriles, acrylonitriles, and dienes.

58. The method of claim 54, wherein the co-polymerization reaction is an atom transfer radical polymerization reaction comprises a catalyst, wherein the catalyst is a transition metal, a transition metal salt or a transition metal complex, and wherein the transition metal, transition metal salt or transition metal complex is selected from the group consisting of molybdenum, ruthenium, tellurium, chromium, rhenium, copper, palladium, cobalt, iron, titanium, rhodium, and nickel, or a salt or complex thereof or
wherein the transition metal salt or transition metal complex is selected from the group consisting of a chloride, bromide, nitrate, sulfate, oxide, dioxide, hydroxide, and carbonate salt or complex.

59. The method of claim 54, wherein the co-polymer is a block co-polymer, a graft co-polymer or a brush co-polymer with a molecular weight of about 500 to about 5,000,000 g/mol.

60. The method of claim 54, wherein the co-polymer is of Formula (VI): 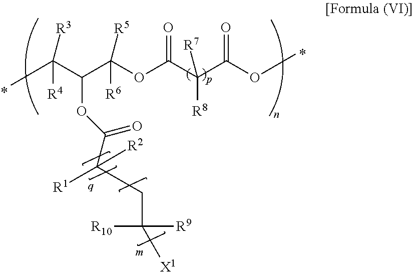
wherein R¹, R², R³, R⁴, R⁵, R⁶, R⁷, R⁸, R⁹, R¹⁰, X¹, n, p and q are as defined in claims 45, 46, 48, 49, 50, 51, and 56; and m is an integer of 1 to 2000 or 1 to 1000 or 40 to 500.

61. The method of claim 54, wherein the co-polymer is of Formula (VIa): 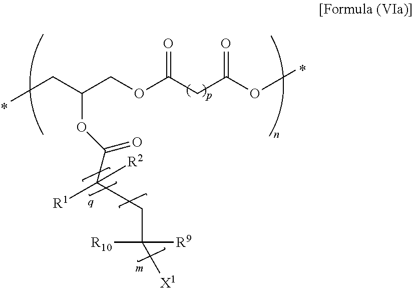
wherein R¹, R², R⁹, R¹⁰, X¹, n, p, q and m are as defined in claims 45, 48, 49, 50, 51, 56 and 60, or
wherein the co-polymer is of Formula (VIb): 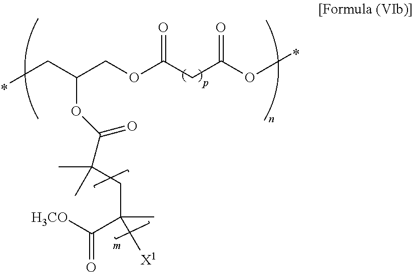
wherein X¹, n, p and m are as defined in claims 45, 49, 50, 51, and 60.

62. A polymer of Formula (IIb): 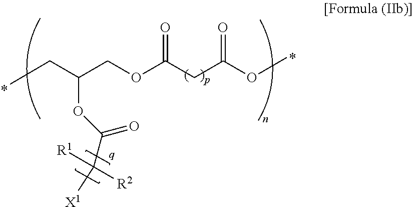
wherein X¹, n, p and q are as defined in claims 45, 46, 49, 50, 51, and 52, or a polymer of Formula (IIc): 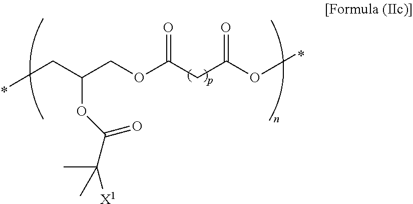
wherein X¹, n and p are as defined in claims 45, 49, 50, and 51, or a polymer of Formula (IId): 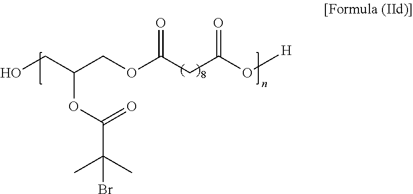
wherein n is as defined in claim 51.

63. A co-polymer of Formula (VIa): 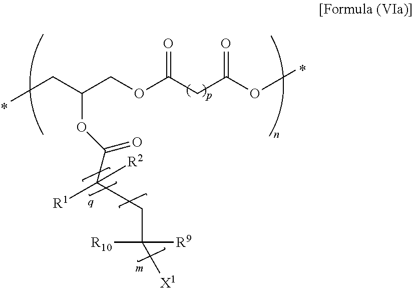
wherein R¹, R², R⁹, R¹⁰, X¹, n, p, q and m are as defined in claims 45, 46, 48, 49, 50, 51, 56, and 60, or a co-polymer of Formula (VIb): 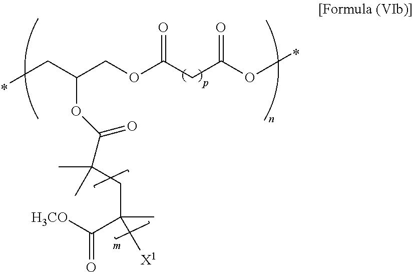
wherein X¹, n, p and m are as defined in claims 45, 49, 50, 51, and 60.

64. An article formed from a co-polymer produced by a method of forming a polymer of Formula (II) comprising:
(i) providing a polyester with at least one free hydroxyl group;
(ii) esterifying said at least one free hydroxyl group with a compound of Formula (I): 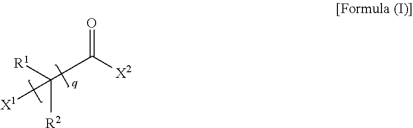
wherein R¹ and R² are independently selected from the group consisting of hydrogen, alkyl, alkenyl, alkynyl, cycloalkyl, aryl, heteroaryl, alkcycloalkyl, alkaryl, alkyl halide, alkyl alcohol and alkheteroaryl, and wherein each of R¹ and R² is optionally substituted with one or more substituents;
X¹ is a halogen;
X² is a chloro, bromo or hydroxyl; and
q is an integer of 1 to 20,
(iii) thereby forming a polymer of Formula (II):
[PE]-O-[Formula (Ia)] [Formula (II])]
wherein PE is a polyester;
—O— is an oxygen linkage; and
Formula (Ia) is: 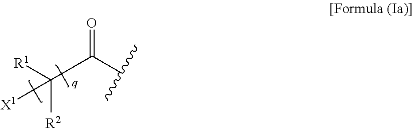
wherein X¹, R¹, R², and q are as defined in operation (ii), or a co-polymer of Formula (VIa): 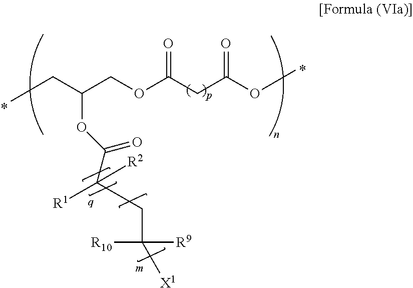
wherein R¹, R², R⁹, R¹⁰, X¹, n, p, q and m are as defined in claims 45, 46, 48, 49, 50, 51, 56, and 60, or a co-polymer of Formula (VIb): 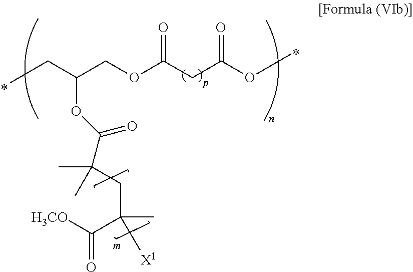
wherein X¹, n, p and m are as defined in claims 45, 49, 50, 51, and 60, or
wherein the article is selected from the group consisting of a biodegradable plastic, biocompatible and/or biodegradable gel for biomedical and consumer products, biocompatible and/or anti-bacterial product, biodegradable and/or biocompatible functional polymer for biomedical and consumer products, surfactant, drug delivery vehicle, cell encapsulation agent, micelle, and trigger sensitive sensing polymer.
